(19) United States
(12) Patent Application Publication
(10) Pub. No.: US 2021/0373601 A1
(43) Pub. Date: Dec. 2, 2021

(54) Curved Touchscreen Adaptive UI

(71) Applicant: Telefonaktiebolaget LM Ericsson (publ), Stockholm (SE)

(72) Inventors: Fredrik Dahlgren, Lund (SE); Alexander Hunt, Tygelsjö (SE)

(21) Appl. No.: 16/884,860

(22) Filed: May 27, 2020

(51) Int. Cl. G06F 1/16; G06F 3/0488; G06F 3/0485; G06F 3/01

(52) U.S. Cl. CPC G06F 1/1641; G06F 1/1647; G06F 1/1652; G06F 2203/04803; G06F 3/0485; G06F 3/013; G06F 3/04886

(57) ABSTRACT

The display disclosed herein receives input via one section of the display and controls another different section of the display responsive to this received input. Exemplary embodiments include a smartwatch, where the display encompasses at least part of the wristband and where multiple display sections are defined for the wristband display. A control circuit for the display receives input from a second display section of the wristband display, e.g., that is not fully visible to the user, and controls the first display section that is visible to the user responsive to the input received by the second display section.

### BACKGROUND

Traditional displays use light emitting diodes to emit combinations of light and colors responsive to input signals to output data on the display. As such, displays have traditionally been output devices. Increasingly, however, displays also operate as input devices, and thus have dual input/output capabilities that allow the user to use the display to provide input to manipulate the information shown on the display and/or regarding operation of the associated device.

Conventional displays are typically confined to an area that is fully visible to the user, e.g., a conventional smartwatch display, a display of a smartphone or tablet, etc. While such displays enable the user to control the displayed output that is visible to the user using touch input on the same display, the user's finger or input tool often blocks the view of the output data on the display. Further, as displays utilize more and more of the device surface area, privacy issues may result for displays that can be seen by more than the authorized user, e.g., a display on an opposite side of the smartphone from the display visible to the user, a display that wraps around a smartphone or a wristband, etc. Thus, there remains a need for improved input and output control of displays for electronic devices.

### SUMMARY

The solution presented herein provides a display where input detected by one section of the display controls a different section of the display. For example, if a smartphone includes a primary display on a front of the smartphone and a secondary display on a back of the smartphone, touch input applied to the secondary display may result in a scrolling operation on the primary display. In so doing, the solution presented herein enables the user to control different sections of a device's display while maintaining full visibility of the section of the display outputting data to the user.

One exemplary embodiment comprises a display for an electronic device. The display comprises a plurality of diodes, a plurality of dynamically adjustable display sections, and a control circuit. Each of the dynamically adjustable display sections is associated with a different subset of the plurality of diodes. The control circuit is configured to independently control the plurality of display sections by controlling a first display section of the plurality of dynamically adjustable display sections responsive to input received by a second display section of the plurality of dynamically adjustable display sections. For example, in one exemplary embodiment, the electronic device is a smartwatch, where the display wraps around at least part of the user's wrist, e.g., the wristband of the smartwatch comprises at least part of the display. In this exemplary embodiment, the first display section may be a portion of the display that is visible to the user, while the second display section may be a portion of the display that is not fully visible to the user, where these first and second display sections dynamically change as the user moves, causing the visible portions of the display to change. Accordingly, user input received by the second display section, e.g., scrolling or gesture input, controls the functionality of the first display section.

In some exemplary embodiments, the control circuit is further configured to control the first display section responsive to additional input received by the first display section.

In some exemplary embodiments, the control circuit is further configured to control the second display section responsive to additional input received by the first display section.

In some exemplary embodiments, the display comprises a continuous display. In some exemplary embodiments, the continuous display comprises a flexible continuous display.

In some exemplary embodiments, the electronic device comprises a watch securable to a user via a watchband, and wherein the display comprises at least a portion of the watchband.

One exemplary embodiment comprises a method of controlling different display sections of a display of an electronic device. The method comprises defining a plurality of dynamically adjustable display sections, where each of the dynamically adjustable display sections is associated with a different subset of diodes of the display. The method further comprises independently controlling the plurality of dynamically adjustable display sections by controlling a first display section of the plurality of dynamically adjustable display sections responsive to input received by a second display section of the plurality of dynamically adjustable display sections.

One exemplary embodiment comprises a computer program product stored in a non-transitory computer readable medium for controlling a display in an electronic device. The computer program product comprises software instructions which, when run on a control circuit in the electronic device, causes the control circuit to define a plurality of dynamically adjustable display sections, each of which is associated with a different subset of diodes of the display. The software instructions, when run on the control circuit, further causes the control circuit to independently control the plurality of dynamically adjustable display sections by controlling a first display section of the plurality of dynamically adjustable display sections responsive to input received by a second display section of the plurality of dynamically adjustable display sections.

### BRIEF DESCRIPTION OF THE DRAWINGS

FIG. 1 shows a block diagram of an electronic device according to exemplary embodiments of the solution presented herein.

FIG. 2 shows a display according to exemplary embodiments of the solution presented herein.

FIG. 3 shows a method of controlling a display according to exemplary embodiments of the solution presented herein.

FIG. 4 shows an electronic device according to exemplary embodiments of the solution presented herein.

FIGS. 5A-5B show an electronic device according to exemplary embodiments of the solution presented herein.

FIG. 6 shows an electronic device according to exemplary embodiments of the solution presented herein.

FIG. 7 shows an electronic device according to exemplary embodiments of the solution presented herein.

FIGS. 8A-8B shows an electronic device according to exemplary embodiments of the solution presented herein.

### DETAILED DESCRIPTION

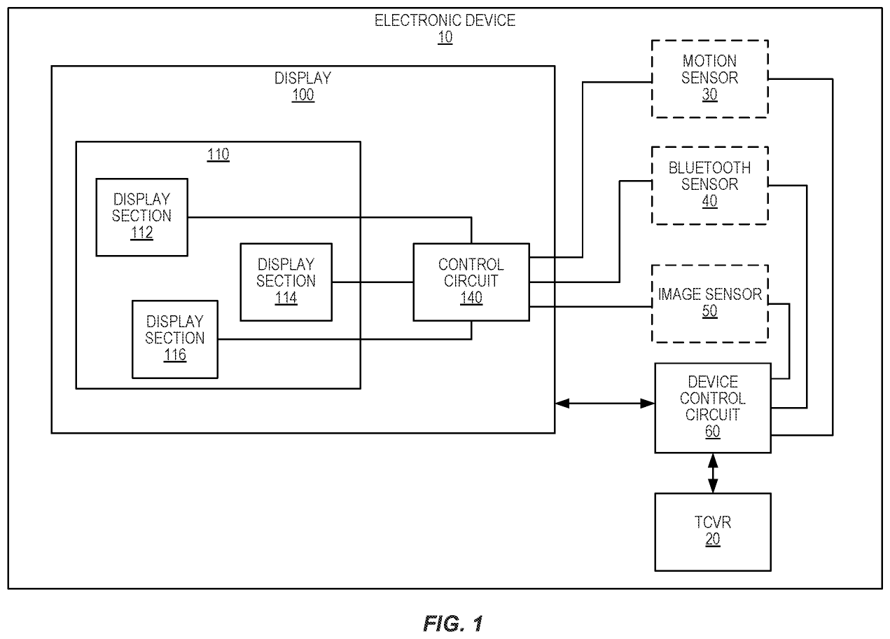

FIG. 1 shows a block diagram of an electronic device 10 having a display 100 according to exemplary embodiments of the solution presented herein. Exemplary electronic devices 10 comprises any electronic device with a display, including, but not limited to, mobile communication devices (e.g., a cellular telephone, a tablet, a watch, etc.), televisions, computers, etc.

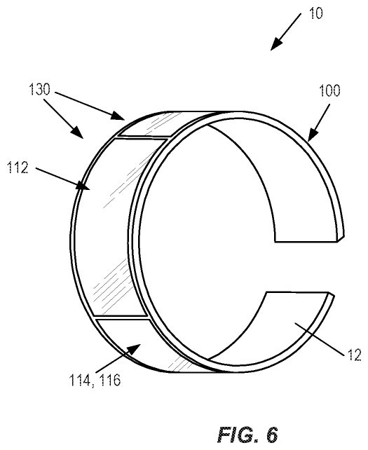

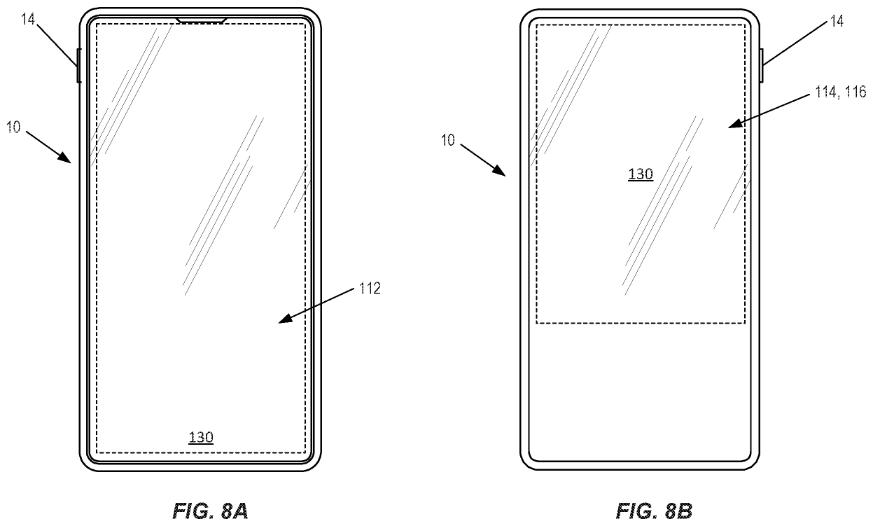

In addition to the display 100, the electronic device 10 comprises a transceiver 20 and a device control circuit 60. Transceiver 20 may comprise a wireless and/or wired transceiver, where the applicable communication standards govern the operation of the transceiver 20 to transmit and/or receive signals applicable to the operation of the electronic device 10. Device control circuit 60 controls the operation of the device 10 according to any known standards applicable to the device 10. Display 100 is configured to output data as well as receive input, as discussed further herein. In some embodiments, display 100 may comprise a single continuous display, which may be rigid or flexible. In other embodiments, display 100 may comprise a segmented display with distinct display segments 130 located in different locations on the electronic device 10, e.g., a front display segment and a back display segment of a smartphone, where each display segment may comprise a rigid display segment or a flexible display segment. It will be appreciated that a segmented display may comprise adjacent display segments (e.g., FIG. 6) and/or spaced apart display segments (e.g., FIG. 8).

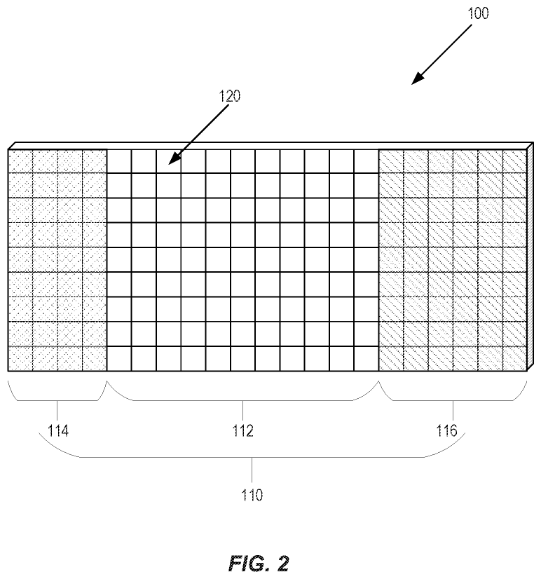

Regardless of whether display 100 comprises a continuous or a segmented display, the display 100 comprises a control circuit 140 and a plurality of diodes 120, which are divided between a plurality 110 of display sections 112-116 such that different display sections 112-116 are associated with different subsets of the display diodes 120, as shown e.g., FIG. 2. According to the solution presented herein, the display sections may be fixed, e.g., preconfigured for a particular device, or may be dynamically configured, e.g., such that the display sections change depending on configuration and/or detected motion and/or user input. Each display section 112-116 may be adjacent at least one other display section 112-116, e.g., as shown in FIGS. 2 and 6, or may be spaced from another display section 112-116, e.g., as shown in FIGS. 1 and 8A-8B. It will be appreciated that if the display 100 comprises a segmented display, each display segment may comprise one or more display sections 112-116. Further, while the following discusses the solution presented herein in terms of two or three display sections 112, 114, 116, it will be appreciated that the solution presented herein applies to any display 100 having two or more display subsections.

As noted above, each display section 112-116 comprises a subset of adjacent diodes 120 of the display 100, where the number of diodes in each subset is less than the total number of diodes in the display 100. While the diodes 120 in each display section 112-116 always include emitting diodes, in some embodiments one or more display sections 112-116 may also include one or more sensing diodes, which may sense user input according to any known means.

Control circuit 140 defines and independently controls each display section 112-116, e.g., controls one display section 112-116 responsive to input received by another display section 112-116. While FIG. 1 shows the control circuit 140 as part of the display 100, it will be appreciated that all or part of the control circuit 140 may alternatively be implemented as part of a device control circuit 60, and thus may be separate from and operatively connected to the display 100. As such, the control of the display 100 disclosed herein may be implemented by the control circuit 140 and/or the device control circuit 60. While not required, the electronic device 10 may include additional sensors, e.g., a motion sensor 30, a Bluetooth sensor 40, and/or an image sensor 50, any one or more of which may provide additional input to the control circuit 140 to further control the display 100, a particular display section112-116, and/or define the display sections 112-116, as discussed further herein. In all cases, the control of each display section 112-116 by the control circuit 140 is the control of the diodes 120 in the corresponding display section 112-116 by the control circuit 140.

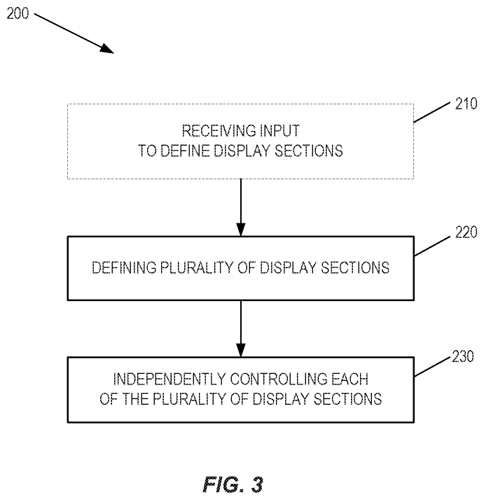

FIG. 3 shows an exemplary method 200 for controlling the display 100 of FIG. 1. Method 200 comprises the control circuit 140 defining a plurality 110 of dynamically adjustable display sections 112-116 (block 220). Each of the plurality 110 of display sections 112-116 is associated with a different subset of diodes 120 of the display 100. The method 200 further comprises the control circuit 140 independently controlling the plurality 110 of dynamically adjustable display sections 112-116 (block 230) by controlling a first one of the plurality 110 of display sections 112-116 responsive to input received by a different one of the display sections 112-116. For example, responsive to user touch input applied to display section 114, 116, control circuit 140 controls the output displayed by display section 112, e.g., selects a message to view, scrolls through a message, applies zoom control to an image displayed in display section 112, change the volume of sound emitted by the device 10, etc. Such independent control enables the user to control the data output in display section 112 without obscuring the output data, and enables different types of input to be provided by different display sections 112-116. While the following describes the solution presented herein in terms of a first display section 112 and a second display section 116 and/or a third display section 114, it will be appreciated that any of the display sections 112-116 may comprise the first display section and any of the display sections 112-116 may comprise the second display section (or a third display section).

The control circuit 140 may apply any known control to the first display section 112 responsive to the input detected by the second display section 116. Exemplary control of the first display section 112 may comprise selection, scrolling, zooming, brightness adjustment (e.g., with respect to emitting diodes in the first display section 112), etc. Exemplary control of the first display section 112 may alternatively or additionally comprise privacy control, e.g., outputting private information on the first display section 112 when the control circuit 140 determines from the second display section input that an authorized user is viewing the first display section 112, or outputting generic information , e.g., date, time, background imager or pattern, etc., on the first display section 112 when the control circuit 140 determines from the second display section input that an unauthorized user is viewing the first display section 112 or that an authorized user is not looking at the first display section 112.

The input detected by the second display section 116 may comprise any known input. Exemplary input may comprise user input applied to the second display section 116, e.g., a touchscreen selection input, a touchscreen scrolling input, a touchscreen swiping input, etc. Exemplary input may alternatively or additionally include other non-contact input detected by the second display section 116, e.g., user motion, eye gaze direction, facial recognition, environmental conditions (e.g., lighting), etc., detected by sensing diodes and/or a camera of the second display section 116, etc.

It will further be appreciated that additional control may be applied to the first display section 112 responsive to additional input received from a display section other than the second display section 116, e.g., input detected by a third display section 114 and/or input detected by the first display section 112. For example, the user may scroll through the multimedia output displayed by the first display section 112 using a scrolling touch input on the second display section 116, and may make a selection, e.g., select a “send” option, by a tap touch input applied to the first display section 112.

In further embodiments, the second display section 116 may also output multi-media data responsive to the control circuit 140. For example, when a second display section 116 and/or a third display section 114 is not visible to an authorized user, the control circuit 140 may control the second display section 116 and/or the third display section 114 to output generic information, e.g., a date, time, background image, or turn off the corresponding diodes 120 to conserve power. Alternatively, the control circuit 140 may control such a second display section 116 and/or the third display section 114 to output user-selected data, e.g., responsive to user input.

For example, the control circuit 140 may be configured to independently control the plurality 110 of dynamically adjustable display sections 112-116 by configuring the first display section 112 to display multi-media data and configuring the second display section 116 to display a current time. In another exemplary embodiment, the control circuit 140 is further configured to independently control the plurality 110 of dynamically adjustable display sections 112-116 by configuring the first display section 112 to display multi-media data and configuring the second display section 116 to turn off emitting diodes in the second display section 116. In another exemplary embodiment, the control circuit 140 is configured to independently control the plurality 110 of dynamically adjustable display sections 112-116 by configuring the first display section 112 to display a current time and/or received multi-media data, and configuring the second display section 116 to display a predetermined design or background image. In another exemplary embodiment, the control circuit 140 is configured to independently control the plurality 110 of dynamically adjustable display sections 112-116 by configuring two or more of the plurality 110 of dynamically adjustable display sections 112-116 to display a predetermined design or background image. It will be appreciated that these examples are provided for illustrative purposes and should not be construed as limiting.

The solution presented herein provides different display sections 112-116 to enable independent control of these different display sections 112-116. The number of display sections 112-116, as well as the size, shape, and location of each display section 112-116 within the display 100, may be predefined and/or defined dynamically responsive to input received by the electronic device 10. In one exemplary embodiment, display 100 may be subdivided into multiple display sections 112-116 such that each diode 120 of the display 100 is in a unique one of the display sections 112-116. For example, FIG. 2 shows a display 110 where the diodes 120 are subdivided into three display sections: a center display section 112, and two smaller edge display sections 114, 116 on opposing sides of the center display section 112. As shown in FIG. 2, each display section 112-116 has a different number of the diodes 120, where each of the diodes 120 in the display is in one of the display sections 112-116, and each display section 112-116 is adjacent at least one other display section 112-116. It will be appreciated, however, that each of these details is exemplary and non-limiting. The solution presented herein applies to any number of display sections, and is not limited to embodiments with two or three display sections. The solution presented herein also applies to any size display section, including equal-sized display sections. Further, the solution presented herein does not require each diode 120 to be in a particular display section. For example, as shown in FIGS. 1 and 8A-8B, some display sections 112-116 may be spaced apart such that the diodes 120 in a particular display section are not adjacent any other diodes of another display section 112-116.

As shown in FIG. 3, the method 200 may optionally include the control circuit 140 receiving input to define the display sections 112-116, e.g., input that may be used to define the number of display sections 112-116, as well as the location, size, and/or shape of each display section 112-116. In some exemplary embodiments, this section defining input may comprise user input during setup of the device 10, e.g., via a “settings” function for preconfiguring the display 100 to define distinct display sections 112-116. In other exemplary embodiments, the control circuit 140 may dynamically define the display sections responsive to dynamically received input. For this dynamic control, the section defining input may comprise display activation input, e.g., received via any part of the display 100 or via a physical control button 14, motion input detected by motion sensor 30, Bluetooth input detected by Bluetooth sensor 40, and/or image input detected by image sensor 50 (e.g., one or more cameras in device 10 and/or sensing diodes in the display 100). For example, the motion sensor 30 may detect movement of the device 10, enabling the control circuit 140 to determine an orientation of the device 10 relative to the user and define the display sections 112-116 accordingly, e.g., by defining a display section visible by the user as the first display section 112 and defining another display section partly or fully invisible to the user as a second display section 116. In another example, the Bluetooth sensor 40 may cooperate with another Bluetooth device associated with the user, e.g., Bluetooth glasses, to determine the direction of the user's gaze relative to the device 10, e.g., via angle of arrival calculations, where the control circuit 140 defines the display sections 112-116 according to this Bluetooth information. In yet another example, the image sensor 50 may capture images associated with the user, e.g., gaze direction, where the control circuit 140 dynamically defines the display sections 112-116 according to this image information. It will be appreciated that the control circuit 140 may dynamically define the display sections 112-116 responsive to one or more different types of input. For example, the control circuit 140 may dynamically define the display sections 112-116 responsive to a device orientation determined from motion sensor output and gaze direction information determined from image sensor and/or Bluetooth sensor output. Such orientation-based defining of the display sections 112-116 enables the control circuit 140 to subsequently apply orientation-specific control to each display section 112-116 and/or to define display sections based on which diodes 120 are visible to the user and which diodes 120 are not visible to the user. For example, the control circuit 140 may use gaze direction information to determine which diodes 120 are visible to the user, and define the first display section112 as containing at least some of the diodes 120 visible to the user and the second display section 116 as containing at least some of the diodes 120 not visible to the user. It will further be appreciated that the display sections 112-116 may be predefined, e.g., via user settings, and then subsequently dynamically defined during operation of the device 10.

The size, shape, location, and number of the display sections 112-116 within display 100 may depend on the size, shape, and/or type of display 100 used for device 10. For example, different display sections 112-116 may be defined for flexible displays that wrap around a user's wrist than would be defined for a flat, rigid display, e.g., that of a smartphone.

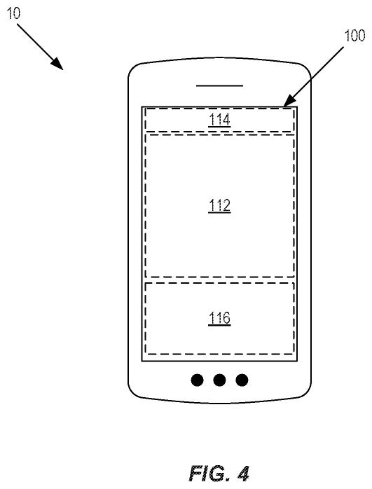

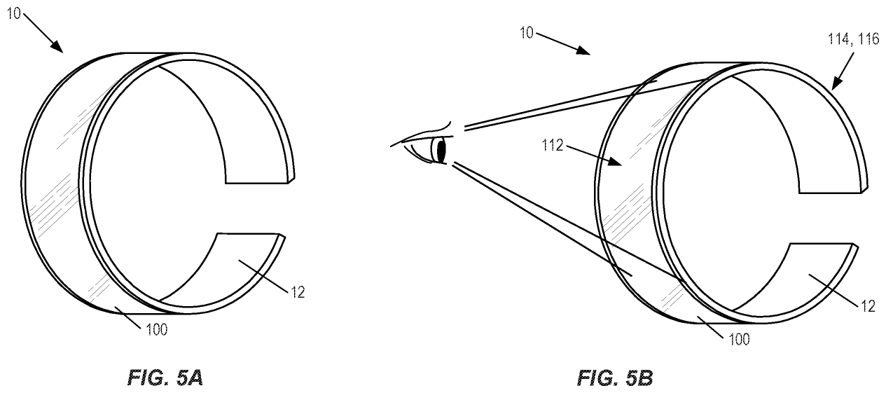

FIGS. 4-8B show exemplary displays 100 applicable to the solution presented herein. For the displays 100 where some portion of the display is not always visible to the user, e.g., the exemplary displays 100 of FIGS. 5-8B, the portions of the display 100 visible to the user and the portions of the display 100 not visible to the user changes depending on the orientation of the device 10 and/or the direction of the user's gaze. The control circuit 140 of the solution presented herein addresses this problem by defining the size, location, and shape of the different display sections 112-116, and/or by defining different ones of the display sections 112-116 as the “input” and “output” display sections, responsive to input provided to the device 10, e.g., motion input, Bluetooth input, image sensed input, etc.

FIG. 4 shows a rigid display for an electronic device 10, which may comprise a continuous display or a segmented display. This type of display may be suitable for, e.g., a mobile communication device, television, computer monitor, etc. In this exemplary embodiment, the control circuit 140 may define a first display section 112, e.g., in a middle region of the display, for outputting data to the user, and may define one or more additional display section 114, 116, e.g., in an edge region of the display 100, for receiving input used to control the first display section 112. As noted herein, each additional display section 114, 116 may be configured for different types of input, e.g., a second display section 116 may be configured for scrolling touch input while a third display section 114 may be configured for volume control touch input.

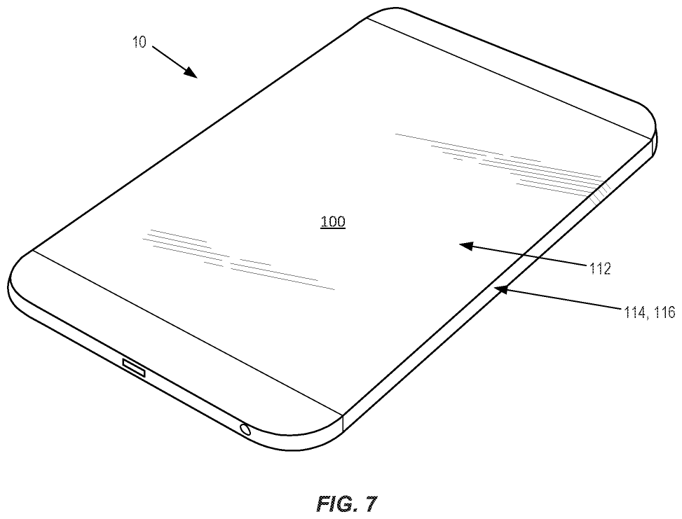

FIG. 5 shows an electronic device 10 comprising a smartwatch, where the display 100 comprises a flexible continuous display that is part of the wristband 12 for the watch. FIG. 6 shows an electronic device 10 comprising a smartwatch, where the display 100 comprises a segmented display that is part of the wristband 12 for the watch, where the segmented display comprises multiple segments 130. FIG. 7 shows an electronic device 10 comprising a cellular telephone or tablet, where the display 100 comprises a flexible continuous display that wraps around from the front to the back of the device 10. FIGS. 8A-8B show an electronic device 10 comprising a cellular telephone or tablet, where the display 100 comprises a segmented display having segments on a front, a back, and/or one or more sides of the device 10. In each of these exemplary embodiments, the control circuit 140 may define a first display section 112 in a portion of the continuous display that is visible to the user, and may define one or more additional display sections 114, 116 in another portion of the continuous display 100 that is not visible to the user, or is less visible to the user. For example, the first display section 112 may be in a portion of the continuous display 100 on a front of the device 10, while the second display section 114, 116 may be in a portion of the continuous display 100 along a side of the device 10 or on a back of the device 10. The control circuit 140 may then control the first display section 112 responsive to input received by the additional display section(s) 114, 116. The control circuit 140 may also control one or more of the additional display sections 114, 116 responsive to input received by the first sections 112 or a different one of the additional display sections. In so doing, not only does the solution presented herein provide different ways to provide different types of input, but it also facilitates privacy controls by enabling independent control of display sections visible to the user relative to display sections not visible to the user, as discussed herein, and further facilitates control without moving the device. For example, when the device 10 of FIG. 7 or FIGS. 8A-8B is lying face down on a desk, the first display section 112 may be in a portion of the continuous display 100 on the back of the device 10, while the additional display section(s) 114, 116 may be in a portion of the continuous display 100 along a side of the device 10. In this example, the user can see the output data on the first display section 112 while providing user input via the second display section 114, 116 without having to pick up the device 10.

As noted herein, additional exemplary embodiments include the control circuit 140 using input received from the first display section 112 to control the data output by the second display section 114, 116. For example, when the display 100 is part of a wristband for a watch, in addition to controlling the output of the first display section 112 responsive to input provided via one or more additional display sections 114, 116, the solution presented herein may further configure the control circuit 140 to control the output of at least one of the additional display sections 114, 116 responsive to input provided via the first display section 112. In one such exemplary embodiment, user input received via one or more additional display sections 114, 116, e.g., scrolling user input, tapping user input, gesturing user input, etc., controls the functionality of the first display section 112. In so doing, the user may apply the control without obscuring their view of the first display section, and may further prevent unauthorized people from viewing sensitive or private data via the additional section(s) 114, 116, e.g., a private message, notification, picture, etc., and/or may share specific data with those able to view the additional display section(s) 114, 116 who otherwise would not easily be able to view the first display section 112.

The solution presented herein may be embodied in hardware (e.g., circuits, modules, and/or units) and/or in software (including firmware, resident software, micro-code, etc.), including an application specific integrated circuit (ASIC). Furthermore, the solution presented herein may take the form of a computer program product on a computer-usable or computer-readable storage medium having computer usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, or a portable compact disc read-only memory (CD-ROM). Note that the computer-usable or computer-readable medium could even be paper or another suitable medium upon which the program is printed, as the program can be electronically captured via, for example, optical scanning or the paper or other medium, then compiled, interpreted, or otherwise processed in a suitable manner, if necessary, and then stored in a computer memory.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A display for an electronic device, the display comprising:
a plurality of diodes positioned contiguously on a rigidly curved or flexible plane;
a control circuit configured to dynamically adjust whether each of the diodes is turned on or off based on an extent to which the diode is visible to a user wearing the electronic device such that:
the diodes that are turned on form a contiguous first display section of the display;
each diode that is turned on is more fully visible to the user than each diode that is turned off; and
the diodes that are turned off form at least one contiguous second display section.

2. The display of claim 1 wherein the control circuit is further configured to control the first display section responsive to input received at the at least one second display section.

3. The display of claim 1 wherein the control circuit is further configured to control the first display section responsive to input received at the first display section.

4. (canceled)

5. The display of claim 1 wherein the display is rigidly curved or flexible at least to such an extent that different sections of the display face opposite directions.

6. The display of claim 1 wherein the control circuit is further configured to control the display responsive to a touchscreen selection input, a touchscreen scrolling input, and/or a touchscreen swiping input received at the at least one second display section.

7. (canceled)

8. The display of claim 1 wherein the control circuit is further configured to control the display responsive to receiving motion information from a motion sensor of the electronic device, the received motion information defining an orientation of the display relative to the user.

9. The display of claim 1 wherein the control circuit is further configured to control the display responsive to receiving screen activation input from the display.

10. The display of claim 1 wherein the control circuit is further configured to control the display responsive to receiving information and/or user eye gaze information from a sensor of the electronic device.

11. The display of claim 1 wherein the control circuit is further configured to control the display responsive to receiving facial recognition information from an image sensor of the electronic device.

12. (canceled)

13. (canceled)

14. The display of claim 1 wherein the display is flexible.

15. The display of claim 1 wherein the electronic device comprises a watch securable to a user via a watchband, and wherein the display comprises at least a portion of the watchband.

16. The display of claim 1 wherein:
the electronic device comprises a wireless communication device having a front surface connected to a back surface;
the display extends from at least a first portion of the front surface to a second portion of the back surface; and
the first portion of the front surface comprises the first display section and the second portion of the back surface comprises the at least one second display section.

17. A method of controlling different display sections of a display of an electronic device, the method comprising:
dynamically adjusting whether each of a plurality of diodes of the display is turned on or off based on an extent to which the diode is visible to a user wearing the electronic device such that:
the diodes that are turned on form a contiguous first display section of the display;
each diode that is turned on is more fully visible to the user than each diode that is turned off; and
the diodes that are turned off form at least one contiguous second display section;
wherein the plurality of diodes is positioned contiguously on a rigidly curved or flexible plane.

18. The method of claim 17 wherein the method further comprises controlling the first display section responsive to input received at the at least one second display section.

19. The method of claim 17 wherein the method further comprises controlling the first display section responsive to input received at the first display section.

20. (canceled)

21. The method of claim 17 further comprising controlling the display responsive to a touchscreen selection input, a touchscreen scrolling input, and/or a touchscreen swiping input received at the at least one second display section.

22. (canceled)

23. The method of claim 17 further comprising controlling the display responsive to receiving motion information from a motion sensor of the electronic device, the received motion information defining an orientation of the display relative to the user.

24. The method of claim 17 further comprising controlling the display responsive to receiving screen activation input from the display.

25. The method of claim 17 further comprising controlling the display responsive to receiving user eye gaze information from a sensor of the electronic device.

26. The method of claim 17 further comprising receiving facial recognition information from an image sensor of the electronic device.

27. (canceled)

28. A non-transitory computer readable medium storing a computer program for controlling a display in an electronic device, the computer program comprising software instructions which, when run on a control circuit in the electronic device, causes the control circuit to:
dynamically adjust whether each of a plurality of diodes of the display is turned on or off based on an extent to which the diode is visible to a user wearing the electronic device such that:
the diodes that are turned on form a contiguous first display section of the display;
each diode that is turned on is more fully visible to the user than each diode that is turned off; and
the diodes that are turned off form at least one contiguous second display section;
wherein the plurality of diodes is positioned contiguously on a rigidly curved or flexible plane.
